(19) United States
(12) Patent Application Publication
(10) Pub. No.: US 2026/0146685 A1
(43) Pub. Date: May 28, 2026

(54) IN-TRENCH PIPELINE WEIGHTING DEVICE

(71) Applicant: 1552818 ONTARIO LIMITED, London (CA)

(72) Inventors: Geoff Weyman CONNORS, Goderich (CA); Travis COTTERILL, London (CA)

(73) Assignee: 1552818 ONTARIO LIMITED, London (CA)

(21) Appl. No.: 19/400,062

(22) Filed: Nov. 25, 2025

Related U.S. Application Data
(60) Provisional application No. 63/725,761, filed on Nov. 27, 2024.

(51) Int. Cl. F16L 1/24

(52) U.S. Cl. CPC F16L 1/24

(57) ABSTRACT

A pipeline weight including: transversely opposing longitudinally extending sidewalls; a plurality of transverse walls transversely bridging the sidewalls and having respective upper and lower edges, wherein two of the transverse walls are longitudinally opposing end walls; and a floor spanning respective lower edges of the sidewalls and the end walls to form a compartment having an upper opening defined by respective upper edges of the sidewalls and the end walls, the floor defining at an underside thereof a longitudinally extending pipeline channel; wherein: the transverse walls are formed of a flexible material; and at least one of the transverse walls is a panel wall forming at least one panel sleeve having a sleeve opening proximal the upper edge of the panel wall.

### BACKGROUND OF THE INVENTION

### Field of the Invention

This patent application claims priority to U.S. Provisional Patent Application No. 63/725,761, filed on Nov. 27, 2024, the entire contents of which is incorporated herein by reference.

The present disclosure relates generally to devices for weighing down pipelines for burial in a trench.

### Background Art

When installing conduits, such as pipes and pipelines, it is common to dig a trench, emplace a pipeline in the trench, and bury the pipeline in the trench under backfill. Such pipeline emplacements, however, are often subject to various forces, such as mechanical, hydrodynamic, and hydrostatic forces that can cause displacement of the pipeline from its originally installed position. Consequentially, the pipeline may rupture, which can have adverse environmental and financial repercussions.

To overcome these forces, pipeline emplacement traditionally entails weighting a pipeline with concrete weights, such as concrete arch structures that can be arranged over the pipeline. Such weighting devices, however, require pre-fabrication offsite, transportation to the place of pipeline emplacement, and then installation about the pipeline. These weighting devices are expensive to manufacture and transport, entail labor-intensive installation practices, and generally require increased trench dimensions so that their installation can be accommodated.

An alternative approach to such pipeline emplacement techniques includes weighting a pipeline with flexible weighting bags. These bags have a large compartment that can be filled with ballast material, such as gravel and coarse sand. Once filled, a weighting bag is positioned over a pipeline such that the bag straddles the pipeline, with the weight of the bag holding the pipeline in position. Some weighting bags include means for preventing excessive compartment bulging when the bags are filled with ballast, such as cables or cords extending between compartment walls. Use of such cords and cables can render use of the bag cumbersome, and may weaken the walls where the cords and cables extend through. Further, where a bag has a single compartment for holding ballast material, damage to the bag during installation can cause a free flow of the ballast material to occur.

U.S. Pat. No. 9,217,516 discloses a conduit weighting device. The device is made of flexible material and has a top loading body for receiving ballast material, and a pair of legs adapted to straddle a conduit. The body has at least one inner panel extending between and joining sidewalls of the legs to prevent excessive bulging when filled with ballast material. The panel also serves to divide the legs into multiple compartments for accepting ballast material, thereby compartmentalizing the contained ballast material to prevent ballast material free flow should the device be damaged. The device may also include filling and hoisting loops for facilitating hoisting the weighting device when filled with ballast material and transporting it to a conduit emplacement.

Some challenges exist related to filling a weighting bag before positioning it over a pipeline. For example, once filled, the weighting bag can be very heavy and cumbersome, requiring careful manipulation of the weighting bag's position and orientation using machinery and/or personnel to position the weighting bag safely and accurately over the pipeline. While some improvements to weighting bags may reduce undesirable forces acting on the pipeline, uneven forces may nevertheless be present on the weighting bag due to misalignments of the filled weighting bag on the pipeline. During filling, the weighting bag is held open and sometimes requires tension while being held to prevent the walls from collapsing. Weighting bags with panels dividing the legs may be subject to uneven filling of the compartments due to bulging or stretching of the interior panels and/or ends. Such uneven filling of the compartments may further cause uneven weight distribution of the weighting bag, which may make it more cumbersome to handle, may cause an uneven weight distribution on the pipeline, and/or may unevenly stress the weighting bag such that rips or tears are more likely.

U.S. Pat. No. 11,231,128 discloses another conduit weighting device formed from flexible sheet material. The device has flaps extending from respective opposite edges of the top opening of the compartment. The compartment forms an underside channel sized and shaped to receive a conduit for conforming placement of the conduit weighting device on the conduit to weight the conduit. The flaps are sized and shaped: when in an open arrangement, to extend beyond edges of a trench containing the conduit to hold open the top opening while receiving the ballast material; and when in a closed arrangement, to close the top opening of the compartment. The weighting device may be placed on an entrenched conduit before filling, and then filled in place with locally-available backfill. The device may be transported to the site in a collapsed compact form.

While the pipeline weighting devices disclosed in U.S. Pat. Nos. 9,217,516 and 11,231,128 overcome drawbacks and provide advantages over previous pipeline emplacement approaches, there remains an ongoing need for further and improved techniques for pipeline weighting.

### BRIEF DESCRIPTION OF THE FIGURES

Embodiments of the present disclosure will now be described, by way of example only, with reference to the attached Figures.

FIG. 1 is a perspective view of a pipeline weight in a trench on a pipeline.

FIG. 2 is a top plan view of the pipeline weight of FIG. 1 in isolation.

FIG. 3 is a front elevation view of the pipeline weight of FIG. 1.

FIG. 4 is a perspective view of the pipeline weight of FIG. 1 configured with an end wall that has a single panel sleeve.

FIG. 5 is a detail view of the end wall of the pipeline weight of FIG. 4.

FIG. 6 is a perspective view of the pipeline weight of FIG. 4 showing insertion of a rigid panel into the panel sleeve.

FIG. 7 is a perspective view of the pipeline weight of FIG. 6 with the panel sleeve in a closed configuration.

FIG. 8 is a perspective view of the pipeline weight of FIG. 7 on a pipeline in a trench, wherein the pipeline weight is being filled with ballast material.

FIG. 9 is a perspective view of the pipeline weight of FIG. 8 in a closed configuration.

FIG. 10 is a perspective view of a pipeline weight configured with an end wall that has multiple panel sleeves.

FIG. 11 is a detail view of the end wall of the pipeline weight of FIG. 10.

FIGS. 12 & 13 are perspective views of the pipeline weight of FIG. 10 showing insertion of a plurality of rigid panels into the panel sleeves.

FIG. 14 is a perspective view of a pipeline weight that has multiple flaps.

FIG. 15 is a flowchart for a method for weighting a pipeline.

Throughout the drawings, sometimes only one or fewer than all of the instances of an element visible in the view are designated by a lead line and reference character, for the sake only of simplicity and to avoid obfuscation. It will be understood, however, that in such cases, in accordance with the corresponding description, that all other instances are likewise designated and encompassed by the corresponding description.

In the drawings and this description, the use of a brace (‘{‘or’}’) between reference characters designates a genus and species relationship, such that “A {B” indicates that ‘B’ is a species of a broader genus ‘A’. A numerical reference character suffixed by a letter (e.g. “800A”, “900B”) designates a separate instance of the element designated by the numerical reference character (e.g. “800A”, “800B” are each separate instances of the element designated by “800”).

### DETAILED DESCRIPTION

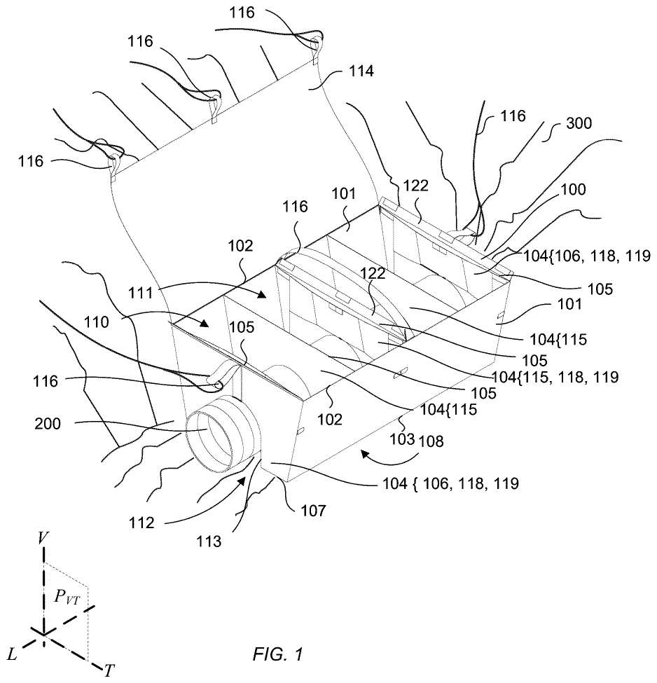

A pipeline weight 100 is shown in FIGS. 1-3. FIG. 1 shows a pipeline weight 100 installed on a pipeline 200 in a trench 300. The pipeline weight 100 may have transversely opposing sidewalls 101 that extend along a longitudinal axis L and a plurality of transverse walls 104 that bridge the sidewalls 101 along a transverse axis T in the vertical-transverse plane, P_{VT}. The sidewalls 101 may have respective upper edges 102 and lower edges 103. The transverse walls 104 may have respective upper edges 105 and lower edges 107 vertically opposite the upper edges 105 along a vertical axis \′. Two of the transverse walls 104 may be longitudinally opposing end walls 106. The pipeline weight 100 may have a floor 108 with an upper side 109, the floor 108 spanning the respective lower edges 103 of the sidewalls 101 and the lower edges 107 of the two transverse walls 104 that form the end walls 106 to form a compartment 110. The compartment 110 may have an upper opening 111 defined by respective upper edges 102 of the sidewalls 101 and the upper edges 105 of the two transverse walls 104 that form the end walls 106, and the floor 108 may define a longitudinally extending pipeline channel 112 along the underside of the floor 108. The pipeline channel 112 may have a semi-circular or semi-obround cross-section (shown particularly in FIG. 3).

Each transverse wall 104 may have a generally flat quadrilateral shape, which may further have a cutout 113 on one side. For example, the quadrilateral shape may be an isosceles trapezoid, and the cutout 113 may be at the shorter side of the isosceles trapezoid, where the shorter side is the lower edge 107 of the transverse wall 104.

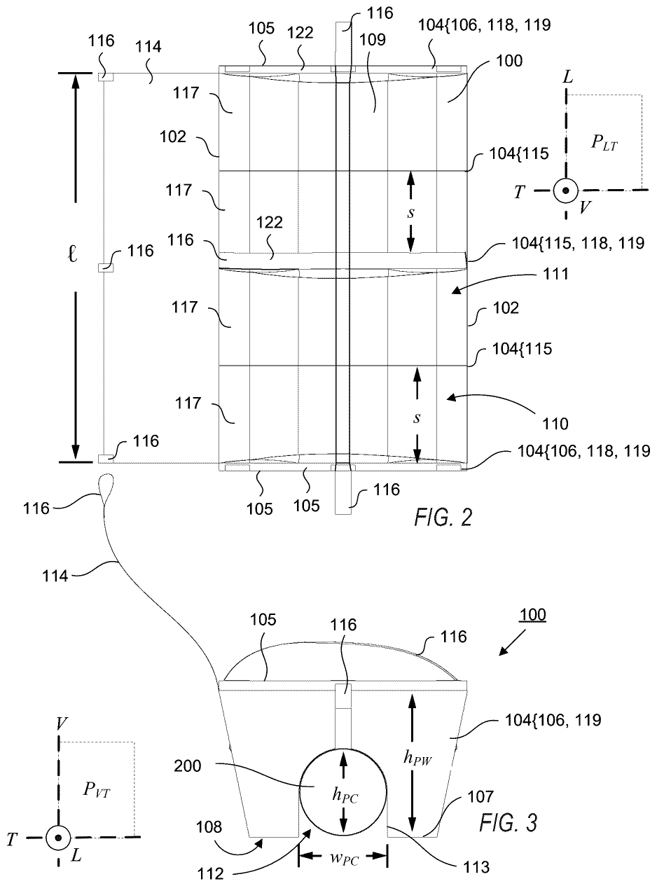

In some embodiments, at least one of the plurality of transverse walls 104 may be a compartment divider 115 that divides the compartment 110 into sections 117 (as shown particularly in FIG. 2). The compartment divider 115 may be a panel wall 118 as described herein. The compartment divider 115 may divide the compartment 110 into equally or unequally dimensioned sections 117. Multiple compartment dividers 115 may divide the container into multiple sections 117 that are equal or different in size, shape, dimension, and/or volume.

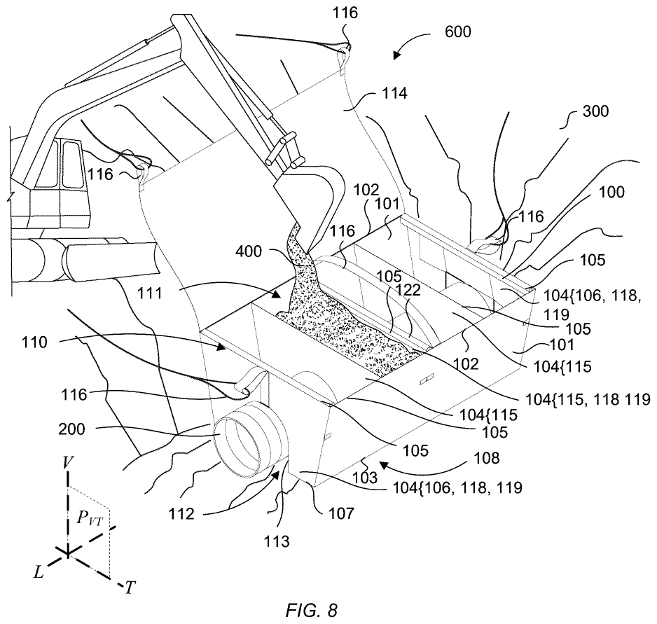

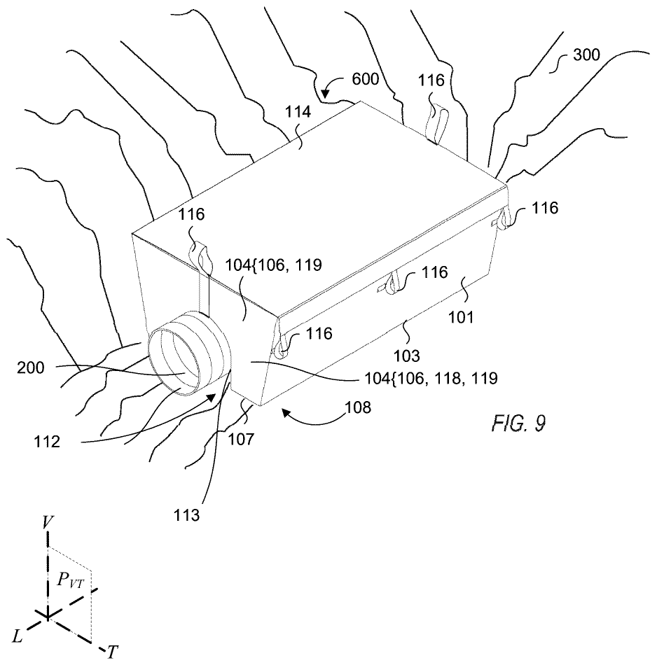

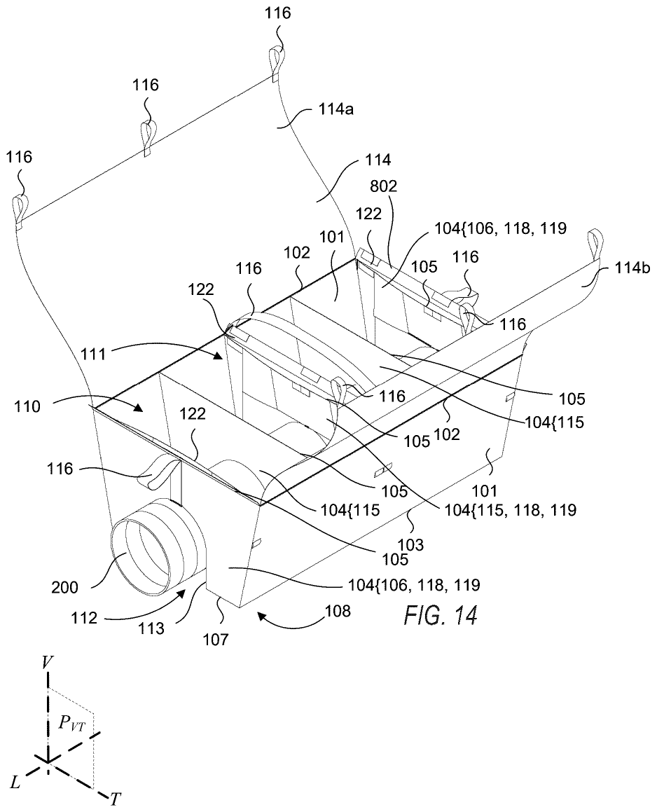

The pipeline weight 100 may have a flap 114 that extends from the upper edge 102 of one of the sidewalls 101 or the upper edge 105 of one of the transverse walls 104 that is an end wall 106. The flap 114 may be sized and shaped to selectively close the upper opening 111 of the compartment 110. For example, the flap 114 may close over the upper opening 111 of the compartment 110 after the compartment 110 has been filled with ballast material 400 (as shown in FIGS. 8-9) to function as a pipeline weight 100. The pipeline weight 100 may have more than one flap 114 in some embodiments (as shown in FIG. 14)

The flap 114, end walls 106 and/or sidewalls 101 may have an anchor 116 to anchor or hold fast the flap 114 selectively in an open configuration (as shown in FIG. 1) or a closed configuration (as shown particularly in FIG. 9). The flap 114 may be anchored in an open configuration to facilitate filling the pipeline weight 100 with ballast material 400 by inhibiting the flap 114 from covering the upper opening 111 during filling. For example, the flap 114 may be operative to direct or facilitate the flow of ballast 400 into the compartment 110 along the slope of the trench 300. The end walls 106 may have an anchor 116 to inhibit collapsing or deforming of the end walls 106 during filling. The pipeline weight 100 may have various anchors 116 for anchoring the pipeline weight 100 in a particular position or orientation before, during, or after filling. The anchor 116 may also be used to manipulate the pipeline weight's 100 position and/or orientation for emplacing the pipeline weight 100 over the pipeline 200. The anchor 116 may be used to connect or anchor the pipeline weight 100 to one or more other pipeline weights.

The anchor 116 may be any anchor suitable for anchoring the flap 114 and/or pipeline weight 100. For example, the anchor 116 may be a strap (such as a strap forming a loop), a hook, a grommet, a weight, or any other suitable anchor. The anchor 116 may be a combination of anchors 116, e.g., a strap with a loop combined with a stake, a grommet combined with a rope, etc. Different anchors 116 may be used in different locations on the pipeline weight 100. The anchor 116 may result from the weight, length, or fabric of the pipeline weight 100 providing sufficient friction, tension, or other force to maintain the pipeline weight 100 in the desired configuration (e.g., the flap 114 in an open configuration).

FIG. 2 is a top view of the pipeline weight 100 of FIG. 1. The pipeline weight 100 may have a length, [symbol] . The length (may be from about 4′ to about 16′. Adjacent pairs of the transverse walls 104 may be spaced apart by a spacing s. In different embodiments, adjacent pairs of the transverse walls 104 may be independently spaced apart by a spacing s of about 12″ to about 48″.

FIG. 3 is a front view of the pipeline weight 100 of FIG. 1. The pipeline channel 112 may have a height h_{PC} and a width w_{PC} that may be selected based on the size of the pipeline 200 to be received therein. Typically, the height h_{PC} and the width w_{PC} of the pipeline channel 112 are the same, or substantially so, but it is contemplated that in at least some embodiments they could be different. For example, the pipeline channel 112 height h_{PC} and width w_{PC} may independently be greater than the width and height of the pipeline 200, or the pipeline channel 112 height h_{PC} and width w_{PC} may independently be approximately equal to the width and height of the pipeline 200. The pipeline weight 100 may have a height of about h_{PW}. The pipeline weight 100 may have a height of h_{PW}. In different embodiments, the pipeline channel 112 height h_{PC} may be from about 2″ to about 56″ (e.g., the vertical diameter). In different embodiments, the pipeline channel 112 width w_{PC} may be from about 2″ to about 56″ (e.g., the horizontal diameter). In different embodiments, the pipeline weight 100 height h_{PW} may be from about 12″ to about 96″.

The pipeline weight 100 may be formed of any suitably flexible and durable material suitable to endure either subterranean conditions associated with pipeline-emplacement, or other environmental conditions to which a particular application may leave it exposed. The material may be a woven or non-woven material, or a breathable woven or non-woven material. Alternatively, the material may include polymer products, such as polypropylene, polyester, or nylon fabrics, that may be of a heavy gauge or a light gauge. The material may include woven geotextile fabric, or needle-punched geotextile fabric. The material may have a density of between 100 and 1000 grams per square metre (GSM), or between 200 and 600 GSM, or between 250 and 350 GSM, or about 300 GSM. When light gauge materials are used, the overall mass of the pipeline weight 100 may be reduced relative to devices formed of heavy gauge materials, which may reduce manufacturing, transportation, and installation costs of the pipeline weight 100 in-trench. The compartment 110 of the pipeline weight 100 and the flap 114 may respectively be formed of different materials. For example, the flap 114 may be formed of stiff, coated fabrics (e.g., shiny side in, 270 gsm), and may include grommets (e.g., anchor 116) formed of plastic or metal, or fabric loops. The pipeline weight 100 may include webbing formed of tensile polymer products such as polypropylene or polyethylene. The pipeline weight 100 may further include thread formed of high tensile standard bulk bag type polypropylene. Further combinations are possible.

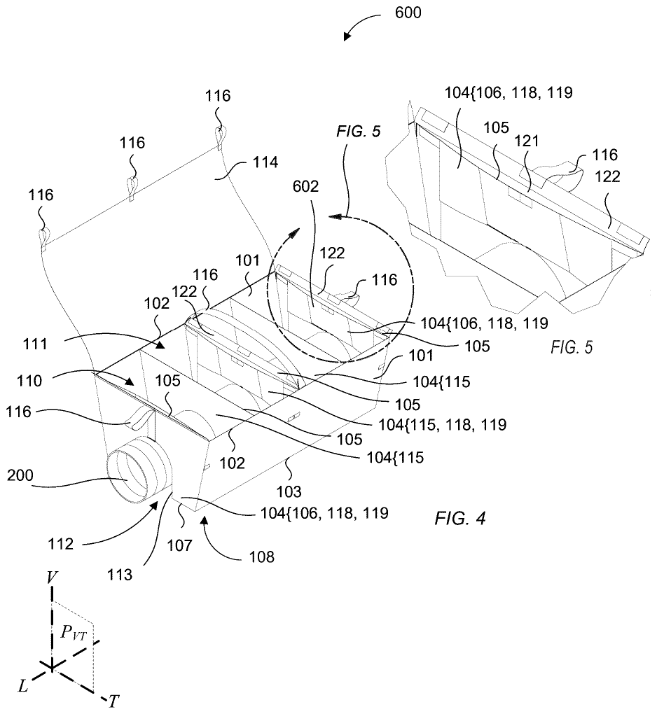

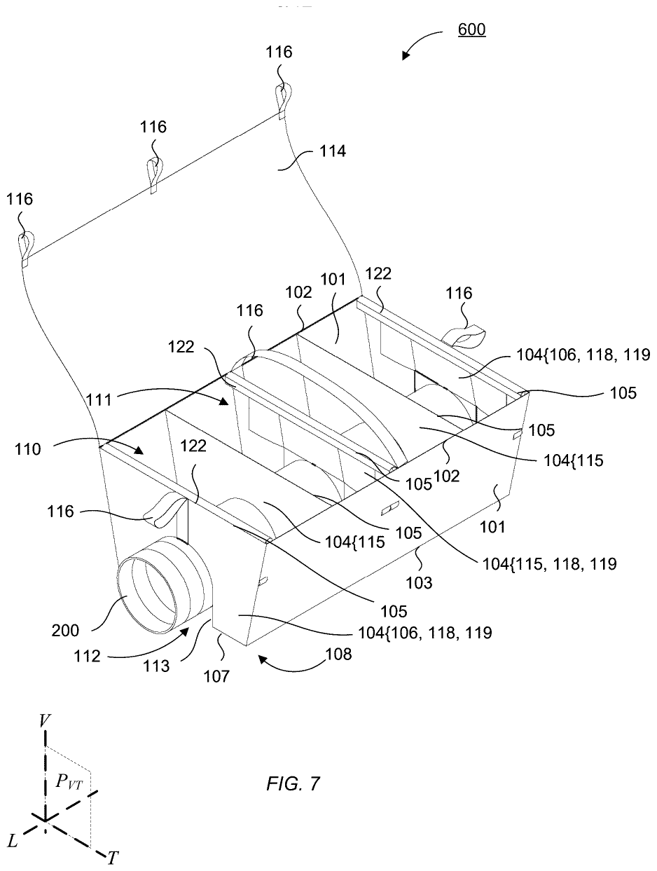

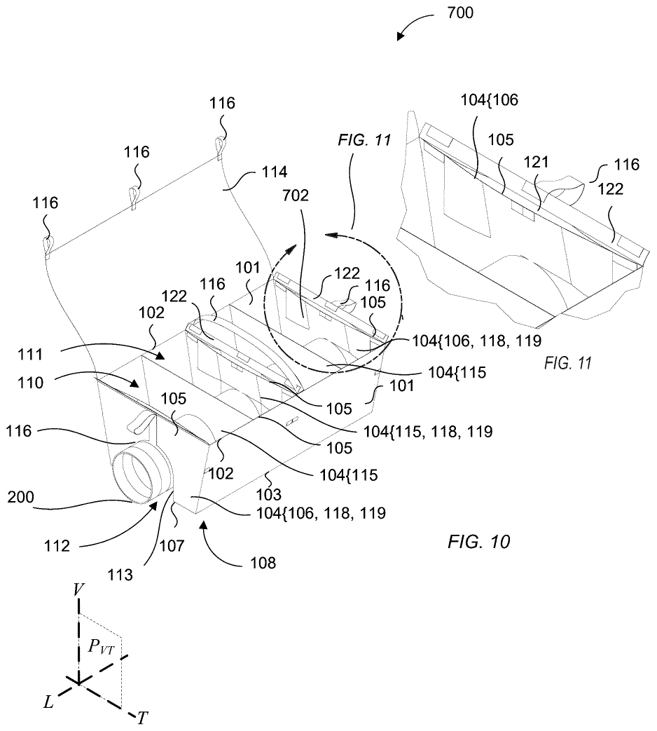

FIGS. 4-9 show a system 600 that has a pipeline weight 602 and a flat rigid panel 120 according to any of the embodiments disclosed herein. At least one of the transverse walls 104 may be a panel wall 118 that forms at least one panel sleeve 119. For example, one or more of the end walls 106 may form at least one panel sleeve 119 (shown particularly in FIG. 5), and/or one or more of the transverse walls 104 interior to the compartment 110 may be a panel sleeve 119. The pipeline weight 602 may have a combination of transverse walls 104 that are or have panel sleeves 119 and are not or do not have panel sleeves 119. The panel sleeve 119 may have an opening 121, for example, in proximity to the upper edge 105 of the transverse wall 104, and which may form a pocket to receive a flat rigid panel 120 (as shown by arrows 123 in FIG. 5). The panel sleeve 119 may be a single sleeve that extends substantially the entire width of the panel wall 118 when the panel sleeve 119 extends between the sidewalls 101. The panel sleeve 119 may include a plurality of sleeves to form a panel sleeve 119 with multiple pockets (as shown in FIGS. 10-14, for example). The panel sleeve 119 may have a loop or handle, which may be, for example, an anchor 116 for the pipeline weight 602.

In some embodiments, the panel sleeve 119 may extend the entire width of the panel wall 118 when the panel sleeve 119 extends between the sidewalls 101. The panel sleeve 119 may extend substantially or entirely the height of the panel wall 118 when the panel sleeve 119 extends from or between the sleeve opening to the lower edge 107 of the transverse wall 104 that is a panel wall 118. In some embodiments, the panel sleeve 119 is one of a plurality of panel sleeves 119 that may collectively extend substantially or entirely an entire width of the panel wall 118 when the panel wall 118 extends between the sidewalls 101. In some embodiments, at least one of the end walls 106 is a panel wall 118. For example, both of the two end walls 106 may be a panel wall 118 that may further have panel sleeves 119.

The panel sleeve 119 may have a closure 122 for enclosing a rigid panel 120 in the panel sleeve 119. The closure 122 may also prevent entry of ballast into the panel sleeve 119. The closure 122 may be any suitable closure for enclosing the rigid panel 120 in the panel sleeve 119. For example, the closure 122 may be a sleeve flap or cover that covers the opening of the panel sleeve 119 (as shown particularly in FIGS. 5, 7, and 11). In different embodiments the sleeve flap may be selectively maintained in a closed configuration using any suitable fastener or closure. In different embodiments the fastener or closure may be straps, snaps, buttons, or hook-and-loop strips (e.g. Velcro™). In some embodiments, one or more of the panel sleeves 119 may not have a closure 122.

The rigid panel 120 may be a flat rigid panel. The rigid panel 120 may have a generally flat quadrilateral shape, which may further have a cutout 121 on one side. For example, the quadrilateral shape may be an isosceles trapezoid, and the cutout 121 may be at the shorter side of the isosceles trapezoid, where the shorter side is the lower edge 107 of the transverse wall 104. The rigid panel 120 may be formed of any material suitable for maintaining a desired rigidity. For example, the rigid panel 120 may be formed of polyethylene, polypropylene, plastic, wood, cardboard, laminated cardboard, or other rigid to semi-rigid materials. The rigid panel 120 may be formed by any structure suitable for maintaining a desired rigidity or rigidity distribution. For example, the rigid panel 120 may have lattice or reinforcement structure to form a substantially rigid panel 120. The rigid panel 120 may be one or more poles/members, or the rigid panel 120 may include poles/members to help form the rigid panel. The rigid panel 120 may be of a size and shape suitable for use in a pipeline weight 602. The one or more rigid panels 120, as the case may be, may be of a size and shape to stiffen the panel wall 118 in which they are installed, thereby to maintain at least partly a flat configuration of the panel wall 118, and in so doing to hold open or apart or otherwise support the sidewalls 101 of the pipeline weight 602. For example, the rigid panel 120 may have a width of about 10″ to about 96″, and a height of about 12″ to about 96″. The rigid panel 120 may allow the compartment 110 to remain in a substantially or entirely open configuration before and/or while the compartment 110 is filled with ballast material 400 (as shown in FIG. 8). For example, the rigid panel 120 may inhibit collapsing, bulging, or other deformation of any one of the sidewalls 101, end walls 106, and/or transverse walls 104.

The embodiments described in reference to FIGS. 4-9 involve using a single rigid panel 120 per panel sleeve 119, which can be useful to maintain the stiffness of the transverse wall 104. In other embodiments, the panel sleeve 119 may have one or more openings, pockets, or other sleeve structures to receive one or more flat rigid panels. As shown in FIGS. 10-13, some embodiments have three rigid panels 124a, 124b, 125, two of which are vertically oriented (124a, 124b), and a third of which is horizontally oriented (125).

FIGS. 10-13 show a system 700 that has a pipeline weight 702 and flat rigid panels 124a, 124b, 125, where the panel sleeve 119 may be configured to receive each of the flat rigid panels 124a, 124b, 125. The pipeline weight 702 may have one or more panel sleeves 119; e.g., the example embodiments shown in FIGS. 10-13 show three panel sleeves 119, but in other embodiments, the system 700 may have fewer or more panel sleeves 119. The system 700 may have some transverse walls 104 that are not panel sleeves 119.

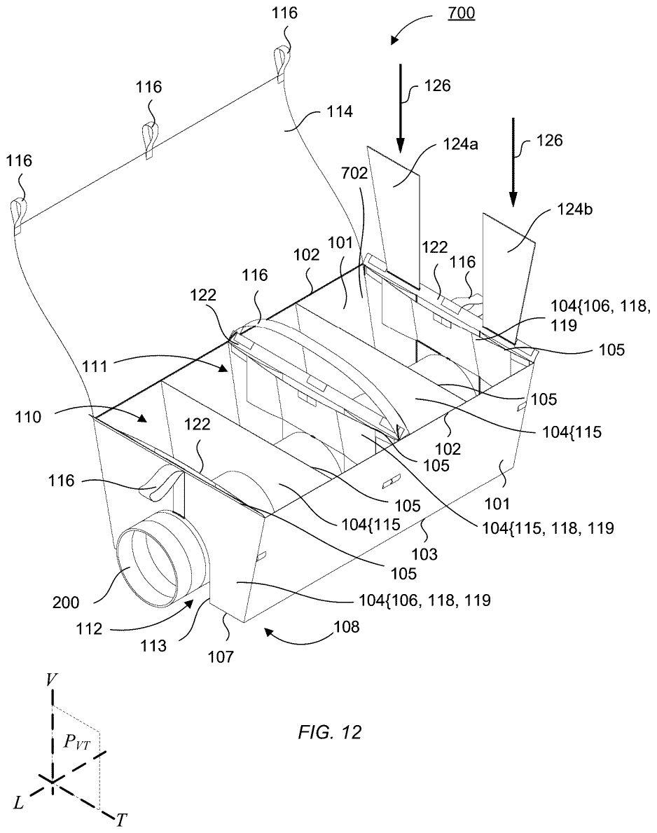

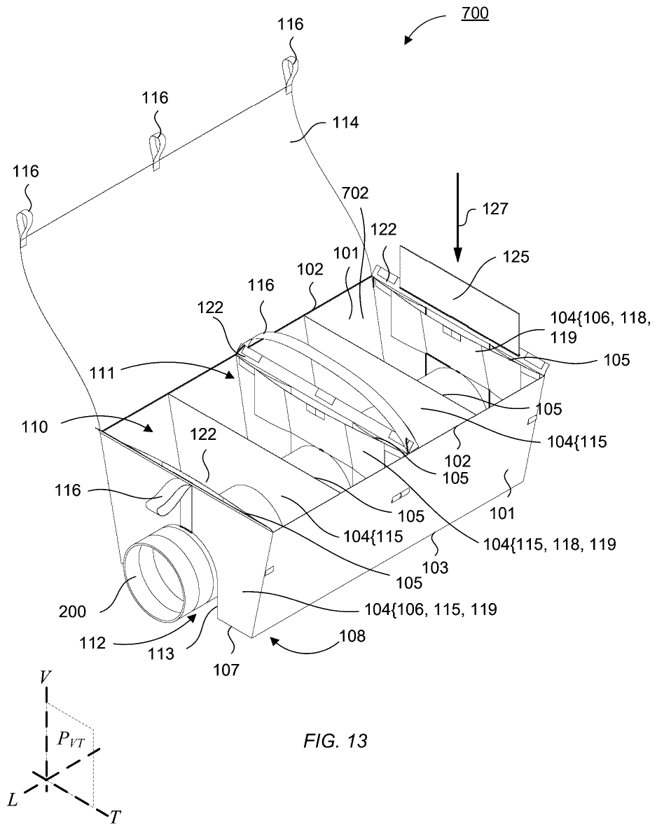

FIG. 12 shows two rigid panels 124a, 124b with a vertical orientation being inserted (as shown by arrows 126) into a panel sleeve 119 on either transverse side of the panel wall 118. FIG. 13 shows a rigid panel 125 being inserted (as shown by arrow 127) into a panel sleeve proximate to the upper edge 105 of the transverse wall 104. The combination of the three rigid panels 124a, 124b, 125 in this embodiment can achieve a substantially similar effect as the single rigid panel 120 described in previous embodiment, e.g., to maintain the stiffness of the transverse wall.

Using multiple rigid panels can be useful, for example, if the rigid panels are composed of a heavy material such that multiple smaller rigid panels are easier to manipulate and insert into the panel sleeve(s) 119. Multiple rigid panels may also facilitate manufacturing and/or transport of the pipeline weight components to the pipeline site. For example, multiple rigid panels may be arranged in pipeline weights of different sizes and/or shapes, which may reduce the number of custom rigid panel designs to be manufactured.

FIG. 14 shows a pipeline weight 802 that has more than one flap 114a, 114b. The flaps 114a, 114b may be positioned to connect and pivot at an upper edge 102 of a sidewall or an upper edge 105 of a transverse wall 104 that is an end wall 106. The flaps 114a, 114b may be configured to selectively open and/or close the compartment 110, for example by overlapping, meeting at an edge, fastening together or being otherwise affixed together and/or in contact with an upper edge 102 of a sidewall or an upper edge 105 of a transverse wall 104 that is an end wall 106. The pipeline weight 802 may have a plurality of flaps 114. For example, the pipeline weight 802 may have one or more flaps 114 on one or more of the upper edges 102 of the sidewalls 101 and/or the upper edges 105 of the transverse walls 104 that form the end walls 106.

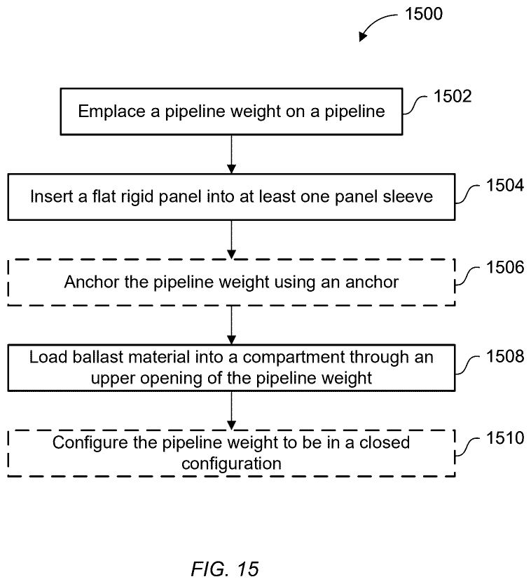

FIG. 15 is a flowchart for a method 1500 for weighting a pipeline. An example embodiment of the method is shown in the progression of FIGS. 4-9.

At 1502, a pipeline weight according to any of the foregoing embodiments may be emplaced on a pipeline 200 such that the pipeline channel 112 of the pipeline weight is positioned and/or aligned on the pipeline 200.

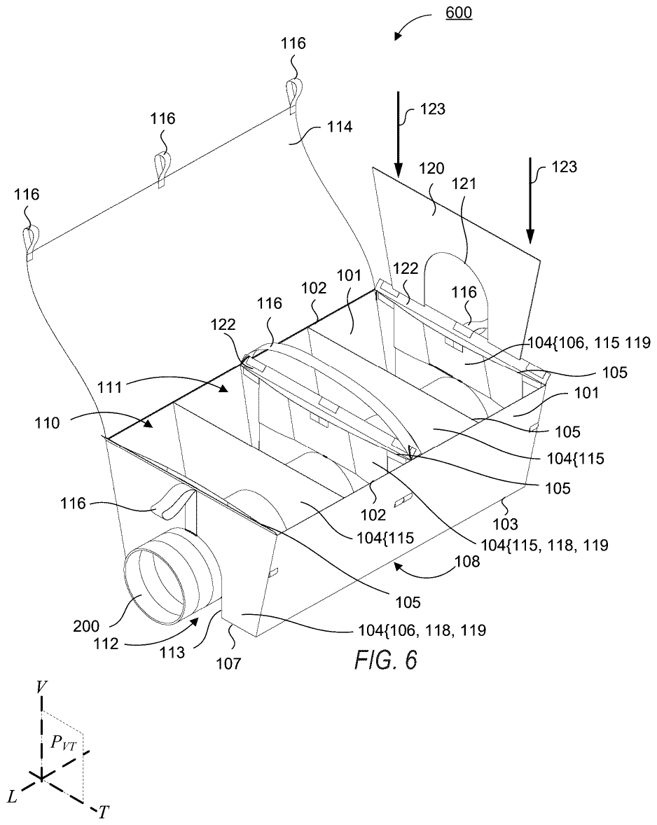

At 1504, a rigid panel may be inserted into at least one of the panel sleeves 119 of any of the foregoing embodiments (as shown particularly in FIGS. 6, 12, and 13, for example). Additional rigid panels may be inserted into the same or different panel sleeves 119 (as shown particularly in FIGS. 12 and 13). In some embodiments, the rigid panel 120 may be inserted into a panel sleeve 119 before the pipeline weight is emplaced on a pipeline 200.

In some embodiments, at 1506, the pipeline weight may be anchored using one or more anchors 116 by machinery and/or personnel. For example, one or more flaps 114 of the pipeline weight may be anchored using an anchor 116 to configure the pipeline weight 100 in an open configuration. Anchoring the flap 114 may allow the compartment 110 to remain in an open configuration to facilitate filling the compartment 110 with ballast material 400. The pipeline weight may be anchored by other anchors 116 and/or in other locations suitable for the context.

At 1508, ballast material 400 is loaded into the compartment 110 through the upper opening 111 (as shown particularly in FIG. 8). The ballast material 400 may be loaded into the compartment 110, or into one or more sections 117 of the compartment 110, as the case may be.

At 1510, the pipeline weight may be configured to be in a closed configuration (as shown particularly in FIG. 9). For example, a flap 114 may be positioned over the upper opening 111 of the compartment 110 to close the compartment 110. The flap 114 may be secured to the compartment 110, to the surrounding environment (e.g., the trench) by additional anchors 116, or unsecured to the compartment 110 (e.g., resting freely over the upper opening 111).

In the embodiments described above, the present disclosure provides a pipeline weight for weighting a pipeline. The pipeline weight may have transverse walls spanning sidewalls that divide the pipeline weight's compartment into sections, which may facilitate an approximately even distribution of ballast in the pipeline weight. This may overcome disadvantages of pipeline weights that are not divided into sections, which can be difficult to position and/or can cause uneven stresses on the material of the pipeline weight leading to failure sooner.

The transverse walls of the pipeline weight according to the embodiments herein may be panel walls including panel sleeves. One or more rigid panels may be inserted into the panel sleeve(s) to stiffen the transverse wall(s). Since pipeline weights are often made of flexible materials, having stiffer transverse walls may help prevent collapse of the pipeline weight's sidewalls and/or end walls while the pipeline weight is being filled with ballast. Similarly, stiffer interior transverse walls may help prevent bulging of the transverse walls while the pipeline weight is being filled with ballast, which may help prevent the different sections of the pipeline weight from being unevenly filled with ballast.

Having at least one substantially stiff transverse wall in the pipeline weight by inserting one or more rigid panels into a panel sleeve of the transverse wall may also facilitate placing the pipeline weight over the pipeline first before filling it with ballast. This overcomes complications related to filling a pipeline weight before emplacing it over a pipeline. For example, the weight and/or size of an already filled pipeline weight can be difficult to handle and may require machinery in addition to personnel to safely and/or accurately emplace the pipeline weight over the pipeline. According to the embodiments described herein, the pipeline weight of the present disclosure may be emplaced over a pipeline before filling the pipeline weight with ballast. The pipeline weight may be of a size, shape, and weight such that one or two people can emplace the empty pipeline weight on a pipeline. The rigid panel(s) that impart stiffness to one or more transverse walls may also be inserted before or after emplacing the pipeline weight on the pipeline. The rigid panel(s) may be of a size and/or shape such that they may be lifted and inserted into the pipeline weight by one or two people.

One or more flaps on the pipeline weight may be multifunctional. For example, the flap(s) may help guide ballast into the pipeline weight and then be used as a cover to contain the ballast in the pipeline weight. The flaps and/or other components of the pipeline weight may use anchors that are fixed, held by a person, and/or held by a machine to maintain the position of the pipeline weight (and/or specifically the flap(s)) during filling.

Accordingly, embodiments of the pipeline weight disclosed herein provide advantages over known pipeline weights, such as facilitating emplacement of a pipeline weight on a pipeline and facilitating filling of the pipeline weight with ballast.

The following are non-limiting embodiments of the subject-matter disclosed herein.

Embodiment 1. A pipeline weight including: transversely opposing longitudinally extending sidewalls; a plurality of transverse walls transversely bridging the sidewalls and having respective upper and lower edges, wherein two of the transverse walls are longitudinally opposing end walls; and a floor spanning respective lower edges of the sidewalls and the end walls to form a compartment having an upper opening defined by respective upper edges of the sidewalls and the end walls, the floor defining at an underside thereof a longitudinally extending pipeline channel; wherein: the transverse walls are formed of a flexible material; and at least one of the transverse walls is a panel wall forming at least one panel sleeve having a sleeve opening proximal the upper edge of the panel wall.

Embodiment 2. The pipeline weight of embodiment 1, wherein: the at least one panel sleeve is a single panel sleeve extending substantially an entire width of the panel wall extending between the sidewalls.

Embodiment 3. The pipeline weight of embodiment 2, wherein: the single panel sleeve extends substantially an entire height of the panel wall extending from the sleeve opening to the lower edge of the panel wall.

Embodiment 4. The pipeline weight of embodiment 1, wherein: the at least one panel sleeve includes a plurality of panel sleeves collectively extending substantially an entire width of the panel wall extending between the sidewalls.

Embodiment 5. The pipeline weight of embodiment 4, wherein: the plurality of panel sleeves collectively extends substantially an entire height of the panel wall extending from the sleeve opening to the lower edge of the panel wall.

Embodiment 6. The pipeline weight of any one of embodiments 1 to 5, wherein: the pipeline channel has a semi-circular or semi-obround cross-section.

Embodiment 7. The pipeline weight of any one of embodiments 1 to 6, wherein: at least one of the end walls is the panel wall.

Embodiment 8. The pipeline weight of any one of embodiments 1 to 7, wherein: at least one of the plurality of transverse walls is a compartment divider dividing the compartment into sections.

Embodiment 9. The pipeline weight of embodiment 8, wherein: at least one of the compartment dividers is the panel wall.

Embodiment 10. The pipeline weight of any one of embodiments 1 to 9, wherein: the sidewalls are formed of the flexible material.

Embodiment 11. The pipeline weight of any one of embodiments 1 to 10, wherein: the floor is formed of the flexible material.

Embodiment 12. The pipeline weight of any one of embodiments 1 to 11, wherein: the flexible material is a geotextile material.

Embodiment 13. The pipeline weight of any one of embodiments 1 to 12, further including: a flap extending from the upper edge of one of the sidewalls or the end walls and sized and shaped selectively to close the upper opening.

Embodiment 14. The pipeline weight of any one of embodiments 1 to 13, wherein: each transverse wall has a generally flat quadrilateral shape having a cutout at one side thereof.

Embodiment 15. The pipeline weight of embodiment 14, wherein: the general flat quadrilateral shape is an isosceles trapezoid; and the cutout is at a shorter base of the isosceles trapezoid.

Embodiment 16. A rigid panel having a generally flat quadrilateral shape and a semi-circular or semi-obround cutout at one side thereof.

Embodiment 17. The rigid panel of embodiment 16, wherein: the generally flat quadrilateral shape is an isosceles trapezoid; and the cutout is at a shorter base of the isosceles trapezoid.

Embodiment 18. The rigid panel of embodiment 16 or 17, wherein: the rigid panel is formed of polyethylene, polypropylene, plastic, wood, cardboard, or laminated cardboard.

Embodiment 19. The rigid panel of any one of embodiments 16 to 18, wherein: the rigid panel has a width of about 10″ to about 96″, and a height of about 12″ to about 96″.

Embodiment 20. A system for weighting a pipeline, the system including: the pipeline weight of any one of embodiments 1 to 15; and at least one rigid panel of any one of embodiments 16 to 19.

Embodiment 21. A method for weighting a pipeline, the method including: emplacing the pipeline weight of any one of embodiments 1 to 15 on the pipeline wherein the pipeline is fittingly received in the pipeline channel; and for at least one of the panel sleeves, inserting into the panel sleeve a flat rigid panel; and loading ballast material into the compartment through the upper opening.

So that the present disclosure may be more readily understood, certain terms are defined. Unless defined otherwise, all technical and scientific terms used herein have the same meaning as commonly understood by one of ordinary skill in the art to which embodiments of the invention pertain. While many methods and materials similar, modified, or equivalent to those described herein can be used in the practice of the embodiments of the present invention without undue experimentation, the preferred materials and methods are described herein.

All terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 11/2, and 43/4. This applies regardless of the breadth of the range.

The terms “about” or “approximately” as used herein refer to variation in the numerical quantity that can occur, for example, through typical measuring techniques and equipment, with respect to any quantifiable variable, including, but not limited to, mass, volume, time, distance, voltage, and current. Further, given solid and liquid handling procedures used in the real world, there is certain inadvertent error and variation that is likely through differences in the manufacture, source, or purity of the ingredients used to make the compositions or carry out the methods and the like. The terms “about” and “approximately” also encompass these variations. Expressions which combine the terms “about” or “approximately” with one or more bounds of a range refer to a union of the bound modified by the term “about” or “approximately” as described above, and the range having the unmodified bound. Thus, for example, the expression “at least about X” means the union of “at least X” and “about X”. Similarly, “at most about Y” means the union of “at most Y” and “about Y”.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”. “Consisting essentially of”, when used in the claims, shall have its ordinary meaning as used in the field of patent law.

Embodiments of the disclosed subject-matter are described herein using the auxiliary verb “may”. When used herein, unless required otherwise by the context of usage, the auxiliary verb “may” designates an embodiment of the disclosed subject-matter which possesses the addressed object without requiring necessarily that any other embodiment of the disclosed subject-matter possesses the addressed object. Thus, a statement such as “X may include Y” indicates that the disclosed subject-matter includes embodiments where X includes Y, without requiring that all disclosed embodiments include Y, and without excluding any other embodiments which do not include Y.

While the disclosed subject-matter may be embodied in many different forms, there are described in detail herein specific embodiments. The present disclosure is an exemplification of the principles of the disclosed subject-matter and is not intended to limit the disclosed subject-matter to the particular embodiments illustrated. Furthermore, the disclosed subject-matter encompasses any possible combination of some or all of the various embodiments mentioned herein. In addition the disclosed subject-matter encompasses any possible combination that also specifically excludes any one or some of the various embodiments mentioned herein.

In the preceding description, for purposes of explanation, numerous details are set forth in order to provide a thorough understanding of the embodiments. However, it will be apparent to one skilled in the art that these specific details are not required. In particular, it will be appreciated that the various additional features shown in the drawings are generally optional unless specifically identified herein as required. The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A pipeline weight comprising:
transversely opposing longitudinally extending sidewalls;
a plurality of transverse walls transversely bridging the sidewalls and comprising respective upper and lower edges, wherein two of the transverse walls are longitudinally opposing end walls; and
a floor spanning respective lower edges of the sidewalls and the end walls to form a compartment having an upper opening defined by respective upper edges of the sidewalls and the end walls, the floor defining at an underside thereof a longitudinally extending pipeline channel;
wherein:
the plurality of transverse walls are formed of a flexible material; and
at least one of the plurality of transverse walls is a panel wall forming at least one panel sleeve having a sleeve opening proximal an upper edge of the panel wall.

2. The pipeline weight of claim 1, wherein:
the at least one panel sleeve is a single panel sleeve extending substantially an entire width of the panel wall extending between the sidewalls.

3. The pipeline weight of claim 2, wherein:
the single panel sleeve extends substantially an entire height of the panel wall extending from the sleeve opening to a lower edge of the panel wall.

4. The pipeline weight of claim 1, wherein:
the at least one panel sleeve comprises a plurality of panel sleeves collectively extending substantially an entire width of the panel wall extending between the sidewalls.

5. The pipeline weight of claim 4, wherein:
the plurality of panel sleeves collectively extends substantially an entire height of the panel wall extending from the sleeve opening to a lower edge of the panel wall.

6. The pipeline weight of claim 1, wherein:
the pipeline channel comprises a semi-circular or semi-obround cross-section.

7. The pipeline weight of claim 1, wherein:
at least one of the end walls is the panel wall.

8. The pipeline weight of claim 1, wherein:
at least one of the plurality of transverse walls is a compartment divider dividing the compartment into sections.

9. The pipeline weight of claim 8, wherein:
the compartment divider is the panel wall.

10. The pipeline weight of claim 1, wherein:
the sidewalls are formed of the flexible material.

11. The pipeline weight of claim 1, wherein:
the floor is formed of the flexible material.

12. The pipeline weight of claim 1, wherein:
the flexible material is a geotextile material.

13. The pipeline weight of claim 1, further comprising:
a flap extending from an upper edge of one of the sidewalls or the end walls and sized and shaped selectively to close the upper opening.

14. The pipeline weight of claim 1, wherein:
each transverse wall comprises a generally flat quadrilateral shape having a cutout at one side thereof.

15. The pipeline weight of claim 14, wherein:
the general flat quadrilateral shape is an isosceles trapezoid; and
the cutout is at a shorter base of the isosceles trapezoid.

16. A system for weighting a pipeline, the system comprising:
a pipeline weight comprising:
transversely opposing longitudinally extending sidewalls;
a plurality of transverse walls transversely bridging the sidewalls and comprising respective upper and lower edges, wherein two of the transverse walls are longitudinally opposing end walls; and
a floor spanning respective lower edges of the sidewalls and the end walls to form a compartment having an upper opening defined by respective upper edges of the sidewalls and the end walls, the floor defining at an underside thereof a longitudinally extending pipeline channel;
wherein:
the plurality of transverse walls are formed of a flexible material; and
at least one of the plurality of transverse walls is a panel wall forming at least one panel sleeve having a sleeve opening proximal an upper edge of the panel wall; and
the system further comprising a rigid panel positioned in the at least one panel sleeve, the rigid panel comprising a generally flat quadrilateral shape and a semi-circular or semi-obround cutout at one side thereof.

17. The system of claim 16, wherein:
the generally flat quadrilateral shape is an isosceles trapezoid; and
the cutout is at a shorter base of the isosceles trapezoid.

18. The system of claim 16, wherein:
the rigid panel is formed of polyethylene, polypropylene, plastic, wood, cardboard, or laminated cardboard.

19. The system of claim 16, wherein:
the rigid panel has a width of about 10″ to about 96″, and a height of about 12″ to about 96″.

20. A method for weighting a pipeline, the method comprising:
emplacing a pipeline weight on a pipeline wherein the pipeline is fittingly received in the pipeline channel, wherein the pipeline weight comprises:
transversely opposing longitudinally extending sidewalls;
a plurality of transverse walls transversely bridging the sidewalls and comprising respective upper and lower edges, wherein two of the transverse walls are longitudinally opposing end walls; and
a floor spanning respective lower edges of the sidewalls and the end walls to form a compartment having an upper opening defined by respective upper edges of the sidewalls and the end walls, the floor defining at an underside thereof a longitudinally extending pipeline channel;
wherein:
the plurality of transverse walls are formed of a flexible material; and
at least one of the plurality of transverse walls is a panel wall forming at least one panel sleeve having a sleeve opening proximal an upper edge of the panel wall;
the method further comprising:
for at least one of the panel sleeves, inserting into the panel sleeve a rigid panel; and
loading ballast into the compartment through the upper opening.
